(19) United States
(12) Patent Application Publication
(10) Pub. No.: US 2011/0266151 A1
(43) Pub. Date: Nov. 3, 2011

(54) Microfluidic systems with electronic wettability switches

(76) Inventor: Fredrik Jansson, Arsta (SE)

(21) Appl. No.: 13/066,769

(22) Filed: Apr. 25, 2011

Related U.S. Application Data
(60) Provisional application No. 61/343,102, filed on Apr. 23, 2010.
(60) Provisional application No. 61/395,388, filed on May 12, 2010.

(51) Int. Cl. C25B 7/00; C25B 15/00; B05D 5/12; B44C 3/08

(52) U.S. Cl. 204/451; 156/219; 204/601; 427/58

(57) ABSTRACT

The present invention concerns microfluidic systems with printed surface structured electronically controllable wettability switches for efficient manipulation of small amounts of fluids. The high performance microfluidic systems of the invention can be used in many applications, e.g. in rapid DNA separation and sizing, cell manipulation, cell sorting and molecule detection.

### CROSS-REFERENCE TO RELATED APPLICATIONS

This application claims priority from U.S. Provisional Patent Application Ser. No. 61/343,102 filed Apr. 23, 2010 and U.S. Provisional Patent Application Ser. No. 61/395,388 filed May 12, 2010.

### FIELD OF THE INVENTION

The present invention relates to microfluidic systems, to a method for the manufacturing of such a microfluidic system and to a method for controlling or manipulating a fluid flow through micro-channels of such a microfluidic system. The microfluidic systems may be used in biotechnological and pharmaceutical applications. Microfluidic systems according to the present invention are compact, cheap and easy to process.

### BACKGROUND OF THE INVENTION

Microfluidics relates to a multidisciplinary field comprising physics, chemistry, engineering and biotechnology that studies the behavior of fluids at volumes thousands of times smaller than a common droplet. Microfluidic components form the basis of so-called “lab-on-a-chip” devices or biochip networks that can process microliter and nanoliter volumes of fluid and conduct highly sensitive analytical measurements.

The fabrication techniques used to construct microfluidic devices are relatively inexpensive and are amenable both to highly elaborate, multiplexed devices and also to mass production. In a manner similar to that for microelectronics, microfluidic technologies enable the fabrication of highly integrated devices for performing several different functions on the same substrate chip.

Microfluidic chips are becoming a key foundation to many of today's fast-growing biotechnologies, such as rapid DNA separation and sizing, cell manipulation, cell sorting and molecule detection. Microfluidic chip-based technologies offer many advantages over their traditional macrosized counterparts. Microfluidics is a critical component in, amongst others, gene chip and protein chip development efforts.

In all microfluidic devices, there is a basic need for controlling the fluid flow, that is, fluids must be transported, mixed, separated and directed through a micro-channel system consisting of channels with a typical width of about 0.1 mm. A challenge in microfluidic actuation is to design a compact and reliable microfluidic system for regulating or manipulating the flow of complex fluids of variable composition, e.g. saliva, urine, serum, plasma and full blood, in micro-channels.

Various actuation mechanisms have been developed and are at present used, such as, for example, pressure-driven schemes, micro-fabricated mechanical valves and pumps, inkjet-type pumps, electro-kinetically controlled flows, and surface-acoustic waves. However, the mechanism most used in today's products is capillary driven flows, largely due to its simplicity. In order to achieve better control of the capillary flows various wettability switches have been developed.

A wettability switch can manipulate a solid surface's ability to maintain contact with a liquid. The wettability is determined by a force balance between adhesive and cohesive forces when the solid surface is in contact with the liquid. Adhesive forces between the solid and the liquid cause a liquid drop to spread across the surface. Cohesive forces within the liquid cause the liquid drop to ball up and avoid contact with the surface. The force balance can be manipulated through various influences such as light, temperature, chemistry, electrochemistry or electric field. Within the area of manipulating small amounts of fluids some kind of electronic influence is preferred due to its rapid actuation and low interference with the fluid.

The first generation of electronically controllable wettability switches developed for manipulating small amounts of fluids had a more or less flat surface and a possible change in contact angle of up to about 40 degrees (see e.g. Microfluidic transport based on direct electrowetting, Satoh et al., J. Appl. Phys., Vol. 96, No. 1, 1 Jul. 2004, A Solid-State Organic Electronic Wettability Switch, Isaksson et al., Adv. Mater. 2004, 16, No. 4, February 17, JP2005199231 and PCT/SE2004/001779). In this first generation of wettability switches, the change in contact angle of up to 40 degrees has turned out to be too small for enabling the secure and reproducible stopping and starting of capillary driven fluid flows needed in commercial microfluidic applications, especially when working with complex fluids (e.g. whole blood, plasma, serum, urine, saliva, etc.) with varying properties.

However, it was known that the wettability is not just dependant on the surface chemistry, but also on the surface roughness. A certain roughness enables the contact area and the adhesion force between a solid surface and a droplet to be reduced, thus causing an increased contact angle.

In order to improve the change in contact angle, second generation wettability switches have been developed with rough surfaces (see e.g. Reversible conversion of conducting polymer films from superhydrophobic to superhydrophilic, Xu et al., Angew. Chem. Int. Ed. 2005, 44, 6009-6012; Dynamic control of surface energy and topography of microstructured conducting polymer films, Wang et al, Langmuir, 2008, 24 (11), 5942-5948; Electrowetting on gold electrodes with microscopic three-dimensional structures for microfluidic devices, Yokomaku et al., J. Appl. Phys. 104, 064910, 2008 and Improvement of the Tunable Wettability Property of Poly(3-alkylthiophene) Films, Lin et al., Langmuir 2009, 25(13), 7465-7470). These references are discussed in more detail below.

The fact that the surface roughness can affect the wetting behavior was mentioned in PCT/SE2004/001779, which covers a flat polymeric wettability switch of the first generation: “The surface topography typically affects the wetting behavior of a surface. This fact can be exploited by patterning the surface with e.g. small spikes or canals. The polymer surface is typically soft enough to facilitate imprint of such patterns using e.g. a die stamp.” When one of the inventors of the above stated patent later prepared surface structured switches in 2007 (see “Wang et al.” below) PPy was instead electropolymerized through micro-patterned photoresist. The use of electropolymerization and photoresist leads to a high production cost and the created PPy pillars actually lowered the contact angle change compared to the smooth PPy surface. What surface pattern and how to make it in order to achieve high performing (in terms of contact angle shift per time unit) and cost effectively produced surface structured wettability switches is thus not obvious to a person skilled in the art.

Xu et al. prepared a surface structured wettability switch through a combined in situ chemical and electrical polymerization of PFOS doped PPy on a flat conducting substrate. The initial contact angle is 155 degrees in its oxidized and PFOS doped state. By holding the switch in a 0.05M solution of TEAPFOS in acetonitrile under −0.6 V vs. Ag/AgCl reference electrode for 20 minutes, the PFOS leaves the PPy and the switch reaches its neutral state. After being washed and dried the final water contact angle is measured to 0 degrees. The use of the combined chemical and electrical polymerization for making the switch and to achieve the surface structure leads to limited performance in terms of possible contact angle shift per time unit and to a high production cost.

Wang et al. prepared surface structured wettability switches through electropolymerization of DBS doped PPy through micro-patterned photoresist, as described above, but also between SU8 micro-pillars on a flat conducting substrate. The hybrid PPy:DBS/SU8 switch showed an increased shift in contact angle with an initial contact angle of 129 degrees when the water mainly rests on the bare SU8 micro-pillars and the PPy was in its unexpanded oxidized state below the bare SU8 pillars. By reducing the PPy for 2 minutes in 0.1 M NaDBS (−1 V vs Ag/AgCl reference electrode) the PPy expands and rises between the SU8 micro-pillars, lowering the roughness, meanwhile the PPy gets more hydrophilic. The combined result is a final contact angle of 44 degrees. The use of SU8 micro-pillars and of electropolymerization for achieving the PPy layer between the pillars leads to limited performance in terms of possible contact angle shift per time unit and a high production cost.

Yokomaku et al. prepared a structured surface switch by forming a PDMS substrate with micro-pillars and then sputter deposit a Cr/Au-layer on top of the micro-structured substrate. The micro-structured PDMS/Cr/Au switch showed an initial contact angle of about 110 degrees for 1 M NaCl and switched instantly down to a final contact angle of about 20 degrees when −1 V was applied vs. a reference electrode. The sputtering for achieving the Cr/Au-layer on top of the micro-structured PDMS leads to a high production cost.

Lin et al. first prepared a structured surface switch by spincoating a P3HT solution with TiO2 nanoparticles on a flat conducting substrate. A very limited increase from 30 to 40 degrees of contact angle change was achieved, due to a limited surface roughness added (i.e. polymer filling the gaps between the particles and smoothening the peaks and valleys, not ending up with a surface consisting of discrete particles). Lin et al. therefore stopped this approach. Lin et al. then prepared a structured surface switch by forming a PDMS substrate with micro-pillars, sputtering the substrate with Cr/Au and then spincoating the substrate with P3HT. The micro-structured PDMS/Cr/Au/P3HT switch showed an initial water contact angle of 147 degrees in the neutral state. After being oxidized in a Na₂SO₄ solution for 3 minutes and then dried the final contact angle was measured to 87 degrees. The sputtering for achieving the Cr/Au-layer on top of the microstructured PDMS and the spincoating of the P3HT on top of the Cr/Au leads to a high production cost.

In contrast with the first generation of switches, the invention described herein is able to achieve a much improved performance through the use of a rough surface. In contrast with the second generation of switches, the invention described herein is able to achieve even better performance in terms of contact angle change per time unit, due to the possibility of having a hierarchical/fractal surface structure (increasing the contact angle in the hydrophobic state and decreasing the contact angle in the hydrophilic state), and a low production cost for the microfluidic system as a whole, due to the possibility of producing the complete surface structured switch through ordinary printing and embossing processes adaptable to large scale production (e.g. roll to roll) of the complete microfluidic chip.

The inventor has surprisingly found that it is possible to produce high performing micro- and/or nano-structured switches cost effectively through depositing the switch materials (e.g. metal, polymer, electrolyte, carbon) by printing processes on top of flat substrates in the form of micro- and/or nano-particles or on top of flat substrates and then micro- and/or nano-structure the substrate by embossing or on top of pre micro- and/or nano-structured substrates or through a combination thereof.

The micro- and/or nanostructured surface leads to high performance in terms of a large contact angle shift per time unit. In the hydrophobic state the micro- and/or nano-structure enables the contact area and the adhesion force between a solid surface and a liquid to be reduced, thus causing an increased contact angle. In the hydrophilic state the micro- and/or nano-structure makes it possible for the liquid to be soaked in to the structure and to wet the surface due to micro- and/or nano-capillary forces, thus causing a decreased contact angle.

The printing and embossing processes make it possible to produce the complete high performing micro- and/or nano-structured wettability switch on a simple substrate (e.g. Plastic foil/Au or plastic foil/Ag/electrolyte/polymer) in large scale (e.g. roll to roll) at low cost. Since the printing and embossing processes also are adaptable to cost effective large scale production (e.g. roll to roll) of the microfluidic chip the processes used leads to a low production cost for the microfluidic system as a whole.

Thus it was an object of the invention to provide an improved microfluidic system with integrated electronic wettability switches with both improved performance in terms of change in contact angle per time unit and suitability for low cost production methods resulting in a considerably lower total manufacturing cost than the microfluidic systems with the wettability switches known in the prior art.

In summary, it has until now not been possible to achieve a microfluidic system with integrated high performance wettability switches at costs and using methods suitable for larger scale commercial production.

### SUMMARY OF THE INVENTION

It is an object of the present invention to provide an improved microfluidic system and method of manufacturing and operating the same. Advantages of the present invention include that it is high performing, inexpensive and easy to process. The above objective is accomplished by a method and device according to the present invention.

In a first aspect, the present invention provides a microfluidic system comprising at least one micro-channel having a wall with an inner side, wherein the microfluidic system furthermore comprises:
a printed micro- and/or nano-structured surface, of which at least the outermost perimeter is a surface switch made of an electronically switchable material, attached to said inner side of said wall; and
means for applying electronic stimuli to the surface switch to cause a change in contact angle.

In a second aspect according to the invention, a method for the manufacturing of a microfluidic system comprising at least one micro-channel is provided. The method comprises:
a first step where an open microfluidic chip is fabricated;
a second step where switches and the means for the electronic stimuli may be formed on a lid; and
a third step where for example such lid is used to seal the open microfluidic chip, with the switch facing the channel.

In a further aspect of the present invention, a method for controlling a fluid flow through a micro-channel of a microfluidic system is provided. The micro-channel has a wall with an inner side. The method comprises:
a first step where the fluid propagates in the micro-channel due to for example pump actuation or capillary forces;
a second step where the fluid stops by a wettability switch, due to its hydrophobic natural state for example; and
a third step where a voltage of for example 1-3 V is applied over the switch towards a reference electrode, causing the surface switch turn to for example its actuated hydrophilic state, letting the flow pass and propagate further.

The microfluidic system according to the invention may be used in biotechnological, pharmaceutical, electrical or electronic applications.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention.

### BRIEF DESCRIPTION OF THE DRAWINGS

FIG. 1 illustrates a partial cross section close-up, in a direction perpendicular to an inner side of a wall of a micro-channel, of a surface switch 10 example according to an embodiment of the present invention. The figure represents a surface switch 10 shaped by discrete particles 12 in the form of spheres on a flat substrate 14 where the particles 12 shape a first, a second and a third surface structure resulting in a hierarchical structure. The main picture illustrates what is referred to as a microstructure and the inset 16 illustrates what is referred to as a nanostructure. The inset 16 also shows a more detailed view of the discrete particles (an enlargement of the particle surface 22) of which at least the outermost perimeter is covered with an electronically switchable material.

FIG. 2 illustrates a partial cross section close-up, in a direction perpendicular to an inner side of a wall of a micro-channel, of a surface switch 10 example according to an embodiment of the present invention. The figure represents a surface switch 10 shaped by discrete particles 12 in the form of tubes 18 on a flat substrate 14 where the particles 12 shape a first, a second and a third surface structure resulting in a hierarchical structure. The main picture illustrates what is referred to as a microstructure and the inset 20 illustrates what is referred to as a nanostructure. The inset 20 also shows a more detailed view of the discrete particles (an enlargement of the particle surface 22) of which at least the outermost perimeter is covered with an electronically switchable material.

FIG. 3 illustrates a partial cross section close-up, in a direction perpendicular to an inner side of a wall of a micro-channel, of a surface switch 10 example according to an embodiment of the present invention having a structured surface 25. The figure represents a surface structured wettability switch 10 where the surface has a first and a second structure resulting in a hierarchical structure. The main picture illustrates what is referred to as a microstructure substrate/(electrode)/(electrolyte)/ESM) 24 and the inset 28 illustrates what is referred to as a nanostructure of which at least the outermost perimeter is covered with an electronically switchable material 26 (ESM) layer with possible electrode and electrolyte layer.

FIG. 4 illustrates a partial cross section close-up, in a direction perpendicular to an inner side of a wall of a micro-channel, of a surface switch 10 example according to an embodiment of the present invention. The figure represents a surface structured wettability switch where the surface has a first, a second and a third surface structure resulting in a hierarchical structure. The main picture illustrates what is referred to as a microstructure and the insets 16, 20 illustrate what is referred to as a nanostructure. The insets 16,20 also show a more detailed view of the discrete particles of which at least the outermost perimeter is covered with an electronically switchable material 26 having a particle surface 27.

FIG. 5 illustrates an example of a surface switch 10 integrated in a micro-channel according to an embodiment of the present invention with a channel wall (side) 30, channel wall (top/lid) 32, and channel wall (bottom/lid) 34. Either the channel top or the channel bottom can be constituted of a lid. Flow in 36 and flow out 38 are shown.

FIG. 6 illustrates an example of a surface switch 10 and a reference electrode 40 integrated in a micro-channel with external connectors 42 and contact pads 44 according to an embodiment of the present invention.

FIG. 7 illustrates the setup of Example 1.

FIG. 8 illustrates the contact angle measurements resulting from the experiment described in Example 1. The photo to the left shows a drop in the switch before switching. The photo to the right shows a photo of a drop after switching.

FIG. 9 illustrates the setup of Example 2

FIG. 10 illustrates the setup of Example 3.

FIGS. 11A-11D illustrate an example of a micro-fluidic chip 64 with an open channel 66 and a micro-fluidic chip covered with a lid 68 according to an embodiment of the present invention, with FIGS. 11A and 11B showing a micro-fluidic chip 64 with open channel 66, FIGS. 11 C and 11D showing a micro-fluidic chip 64 with a channel covered by lid 68, FIGS. 11A and 11C showing top views, and FIGS. 11B and 11D showing side views.

### DETAILED DESCRIPTION OF THE INVENTION AND PREFERRED EMBODIMENTS THEREOF

The present invention will be described with respect to particular embodiments and with reference to certain drawings but the invention is not limited thereto. The drawings described are only schematic and are non-limiting. In the drawings, the size of some of the elements may be exaggerated and not drawn on scale for illustrative purposes. Where the term “comprising” is used in the present description, it does not exclude other elements or steps. Where an indefinite or definite article is used when referring to a singular noun e.g. “a” or “an”, “the”, this includes a plural of that noun unless something else is specifically stated. Furthermore, the terms first, second, third and the like in the description, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description are used for descriptive purposes and not necessarily for describing relative positions. It is to be understood that the terms so used are interchangeable under appropriate circumstances and that the embodiments of the invention described herein are capable of operation in other orientations than described or illustrated herein.

As used herein, the terms “structure” and “structured surface” referring to the microfluidic systems of the invention herein includes both micro-structure and nano-structure.

In a first aspect, the present invention provides a microfluidic system provided with means, which allow for transportation of fluids through micro-channels of the microfluidic system. In a second aspect, the present invention provides a method for the manufacturing of such a microfluidic system. In a third aspect, the present invention provides a method for controlling fluid flow through micro-channels of a microfluidic system. The microfluidic systems according to the invention are economical and simple to process, while also being robust and compact and suitable for very complex fluids (including but not limited to saliva, urine, serum, plasma, whole blood).

A microfluidic system according to the invention comprises at least one micro-channel and at least one integrated actuator, also called surface switch or wettability switch, at an inner side of a wall of the at least one micro-channel.

The materials that may be used to form micro-channels according to the present invention should optimally be such that they after being formed and perhaps also surface modified have the following characteristics:
Electrically insulating
Biocompatible
Inexpensive

In applications where optical read-out is used (e.g. fluorescence) the materials might also need to have the following characteristics:
High light transmittance
Low autofluorescence

In applications where high temperature processes are used (e.g. polymerase chain reaction (PCR), etc.) the materials might also need to have the following characteristic:
Thermally stable

According to the invention, all suitable materials, i.e. materials that are electrically insulating, biocompatible, inexpensive and able to be formed and perhaps also surface modified may be used.

One such class of materials is glass. Glass may be formed by, for instance, etching and can be surface modified. Glass can meet the requirements of being electrically insulating and biocompatible while also having high light transmittance, low autofluorescence and being thermally stabile. However, one important drawback of glass is that it is not inexpensive and not inexpensive to process. Therefore, glass may only be suitable in a limited number of cases.

Another class of such materials is polymers and more specifically thermoplastic and thermoset polymers. Thermoplastic polymers may be formed in a variety of ways, such as by micro-injection molding, hot embossing, laser ablation, laser cutting and die-cutting foil-wise. Thermoset polymers may be formed by for instance reaction injection molding, photolithography and imprint lithography. Polymeric materials can be electrically insulating, biocompatible and cheap while also being cheap to process (e.g. polyethylene terephthalate (PET), epoxy, etc.). Polymeric materials can also have high light transmittance and low autofluorescence (e.g. cyclo olefin polymer (COP), cyclic olefin copolymer (COC), polystyrene (PS), poly(methyl methacrylate) (PMMA), etc.). Polymeric materials can also have a high thermal stability (e.g. COP, COC, polypropylene (PP), etc.). All in all, polymeric materials can meet all the characteristics stated above and can also be easily surface modified.

Both glass and polymers can be surface modified in order to achieve a surface with higher or lower contact angle or a surface with low protein binding. The modification may consist of a monolayer of molecules (e.g. silanes, polyethylene glycol (PEG), etc.) or a layer of any material (e.g. SiO₂, etc.) or any combination thereof.

Because of the above, according to the present invention, the micro-channels may preferably be formed of polymer materials. Therefore, in the further description, the invention will be described by means of polymeric micro-channels. It has, however, to be understood by a person skilled in the art that the present invention may also be applied when materials other than polymers, as described above, are used to form the micro-channels.

The materials that may be used to form surface switches according to the present invention should optimally be such that the surface of the formed surface switch has the following characteristics:
Biocompatible
Electrically conducting
The wettability should be able to be manipulated by altering the voltage over the surface switch towards a reference electrode.

According to the invention, all suitable materials, i.e. materials that are biocompatible, electronically conducting and of which the wettability can be manipulated by altering the voltage may be used. Such materials may include but are not limited to metals, conducting polymers and carbon, hereinafter commonly called electronically switchable materials.

Metals are electrically conducting, can be biocompatible and the wettability can be manipulated through altering the voltage. Most metals do however oxidize or corrode relatively easy which results in a thin insulating oxide layer that prevents the manipulation of the wettability. Noble metals are more resistant to corrosion and oxidation and are therefore preferred due to a better contact between the metal and the liquid and a thereby superior change in contact angle. The metals can be coated with a surface energy-enhancing molecule. As an example, the molecule can have a hydrophobic end attached to the metal surface and a free hydrophilic end that bends down towards the surface when a voltage is applied. Noble metals include but are not limited to Au, Pt, Ir, Os, Ag and Pd. Surface energy enhancing molecules include but are not limited to thiols.

Conducting polymers can be electrically conducting and biocompatible, and the wettability can be manipulated through altering the voltage. Conducting polymers can be doped with surface energy enhancing counter-ions in order to achieve a higher change in contact angle and faster response to an applied voltage. The conducting polymers include but are not limited to polypyrrole (PPy), polyaniline (PANI) and poly(3,4-ethylenedioxythiophene) (PEDOT). The surface energy enhancing counter-ions include but are not limited to sodium dodecylbenzene sulfonate (DBS) and sodium dodecyl sulfate (SDS).

Carbon can be electrically conducting, biocompatible and the wettability can be manipulated through altering the voltage. Carbon can be coated with a surface energy-enhancing molecule. As an example, the molecule can have a hydrophobic end attached to the carbon surface and a free hydrophilic end that bends down towards the surface when a voltage is applied. Carbon can be arranged in a broad range of allotropes including but not limited to graphite, graphene and fullerenes like buckyballs and nanotubes. Surface energy enhancing molecules include but are not limited to thiols.

Because of the above, according to the present invention, at least the outermost perimeter of the surface switches may preferably be formed of either noble metals, conducting polymers or carbon or any combination thereof. Therefore, in the further description, the invention will be described by means of noble metal, conducting polymer or carbon surface switches, commonly mentioned as surface switches. It has, however, to be understood by a person skilled in the art that the present invention may also be applied when other materials than noble metals, conducting polymers or carbon, as described above, are used to form the surface switches.

The microfluidic system according to the invention may be used in biotechnological applications, such as micro-total analysis systems, microfluidic diagnostics, micro-factories and chemical or biochemical micro-plants, biosensors, rapid DNA separation and sizing, cell manipulation and sorting and in various pharmaceutical applications.

The approach of a preferred aspect of the present invention is to integrate surface switches with a micro- and/or nano-rough surface in an electronically switchable material, into micro-channels. Preferably the shaped wettability switches have micro- and/or nano-structures with contact angle increasing properties in the hydrophobic state. Preferably the shaped wettability switches also have micro- and/or nano-structures with contact angle decreasing properties in the hydrophilic state. Hence, one aspect of the invention provides a fluid control device such as a microfluidic chip having means for wide-ranging and fast electronic control of the wettability of at least one surface in the chip.

Preferably the shaped surface switches can have a microstructured surface with contact angle increasing properties. Thus the surface switch can be highly hydrophobic or even superhydrophobic in its “hydrophobic” state. The microstructure can likewise have contact angle decreasing properties in its “hydrophilic” state, causing the surface switch to be highly hydrophilic or even superhydrophilic.

More preferably the shaped surface switches can have a nanostructured surface with contact angle increasing properties. Thus the surface switch can be highly hydrophobic or even superhydrophobic in its “hydrophobic” state. The nanostructure can likewise have contact angle decreasing properties in its “hydrophilic” state, causing the surface switch to be highly hydrophilic or even superhydrophilic.

Most preferably the shaped surface switches can have a nanostructured and microstructured (hierarchical) surface with contact angle increasing properties. Thus the surface switch can be highly hydrophobic or even superhydrophobic in its “hydrophobic” state. The nanostructure and microstructure can likewise have contact angle decreasing properties in its “hydrophilic” state, causing the surface switch to be highly hydrophilic or even superhydrophilic.

The micro- and/or nano-structures may have the geometrical form of, including but not limited to, hills or ridges or paraboloids or pillars or trenches or any combination thereof and have an aspect ratio (structure height/structure width) of approximately 0.1-10. Preferably the aspect ratio is 0.3-10. More preferably the aspect ratio is 0.6-10. Even more preferably the aspect ratio is 1-10. Most preferably the aspect ratio is 1.3-10.

The micro- and/or nano-structures may be arranged in a fine and dense pattern facilitating a reduced contact area between the surface and the liquid in the hydrophobic state and in the same time promoting capillary flow between the structures in the hydrophilic state.

The nanostructure can typically have a peak to valley distance, measured from the top of the structure to the nearest bottom in a direction perpendicular to the substrate, of approximately 1-5000 nm. Preferably the nanostructure has a peak to valley distance of 1-1000 nm. More preferably the nanostructure has a peak to valley distance of 10-1000 mm Most preferably the nanostructure has a peak to valley distance of 10-500 nm.

The nanostructure can typically have a peak to peak periodicity, measured from center to center of the structures, of approximately 1-5000 nm. Preferably the nanostructure has a peak to peak periodicity of 1-1000 nm. More preferably the nanostructure has a peak to peak periodicity of 10-1000 nm. Most preferably the nanostructure has a peak to peak periodicity of 10-500 nm.

The nanostructure can typically have a gap distance, measured from the outside of a structure to the outside of the next, of approximately 1-5000 nm. Preferably the nanostructure has a gap distance of 1-1000 nm. More preferably the nanostructure has a gap distance of 10-1000 nm. Most preferably the nanostructure has a gap distance of 10-500 nm.

The microstructure can typically have a peak to valley distance, measured from the top of a structure to the nearest bottom in a direction perpendicular to the substrate, of approximately 0.01-100 μm. Preferably the microstructure has a peak to valley distance of 0.01-20 μm. More preferably the microstructure has a peak to valley distance of 0.1-20 μm. Most preferably the microstructure has a peak to valley distance of 1-20 μm.

The microstructure can typically have a peak to peak periodicity, measured from center to center of the structures, of approximately 0.01-100 μm. Preferably the microstructure has a peak to peak periodicity of 0.01-20 μm. More preferably the microstructure has a peak to peak periodicity of 0.1-20 μm. Most preferably the microstructure has a peak to peak periodicity of 1-20 μm.

The microstructure can typically have a gap distance, measured from the outside of a structure to the outside of the next, of approximately 0.01-100 μm. Preferably the microstructure has a gap distance of 0.01-20 μm. More preferably the microstructure has a gap distance of 0.1-20 μm. Most preferably the microstructure has a gap distance of 1-20 μm.

A preferred way of achieving the surface structure in an electronically switchable material is by shaping the structure with discrete particles. The particles can be but are not limited to non-conducting particles, conducting particles and electronically switchable particles.

A preferred way is to shape the structure (e.g. by printing, deposition, etc.) with non-conducting particles first and then cover the particles with an electronically switchable material (e.g. by printing, chemical polymerization, chemical plating, etc.). The non-conducting particles can be of any non-conducting material (e.g. SiOx, TiOx, etc.). The non-conducting particles can also have a surface modification in order to be easily covered with the electronically switchable material.

A more preferred way is to shape the structure (e.g. by printing, deposition, etc.) with conducting particles first and then cover the particles with an electronically switchable material (e.g. by printing, electropolymerization, electrodeposition, etc.). The conducting particles can have the structure of a core or a core with one or more shells. At least the outermost perimeter of the particle is made of any conducting material (e.g. metal, conducting polymer, carbon, etc.). The conducting particles can also have a surface modification in order to be easily covered with the electronically switchable material.

A most preferred way is to shape the structure (e.g. by printing, deposition, etc.) with particles that have a surface in an electronically switchable material. The particles with an electronically switchable surface can have the structure of a core or a core with one or more shells. At least the outermost perimeter of the particle is made of an electronically switchable material.

The particles can be of any shape including but not limited to compact forms like spheres, cubes, etc. and extended forms like tubes, rods, etc. The surface of the particles can have any morphology such as smooth, rough, porous, etc. The particles can have diameters from approximately 1 nm to 10 μm. Preferably the particles have a diameter of 1-1000 nm. More preferably the particles have a diameter of 1-500 nm. Most preferably particles have a diameter of 1-300 nm. The particles can have lengths from approximately 1 nm to 1000 μm. Preferably the particles have a length of 0.01-1000 μm. More preferably the particles have a length of 0.1-1000 μm. Most preferably particles have a length of 1-1000 μm. The below mentioned second level of structure refers to the above described nanostructure. The below mentioned third level of structure refers to the above described microstructure.

A preferred way of shaping the structured surface is to deposit particles in a submonolayer, where each particle represents a first level of structure (e.g. single spheres forming a nanostructure, single tubes forming a nanostructure, etc.).

A more preferred way of shaping the structured surface is to deposit particles in a thin multilayer, where each particle represents a first level of structure and where the randomly aggregated particles together form low peaks and shallow valleys representing a second level of structure (e.g. aggregated spheres forming a nanostructure, aggregated tubes forming a nanostructure, etc.).

An even more preferred way of shaping the structured surface is to deposit particles of two sizes in a multilayer, where the smaller particles represents a first level of structure, where the randomly aggregated smaller particles together form peaks and valleys representing a second level of structure and where the bigger particles represents a third level of structure (e.g. aggregated small spheres covering big spheres forming a hierarchical structure, aggregated small tubes covering big spheres forming a hierarchical structure, etc.).

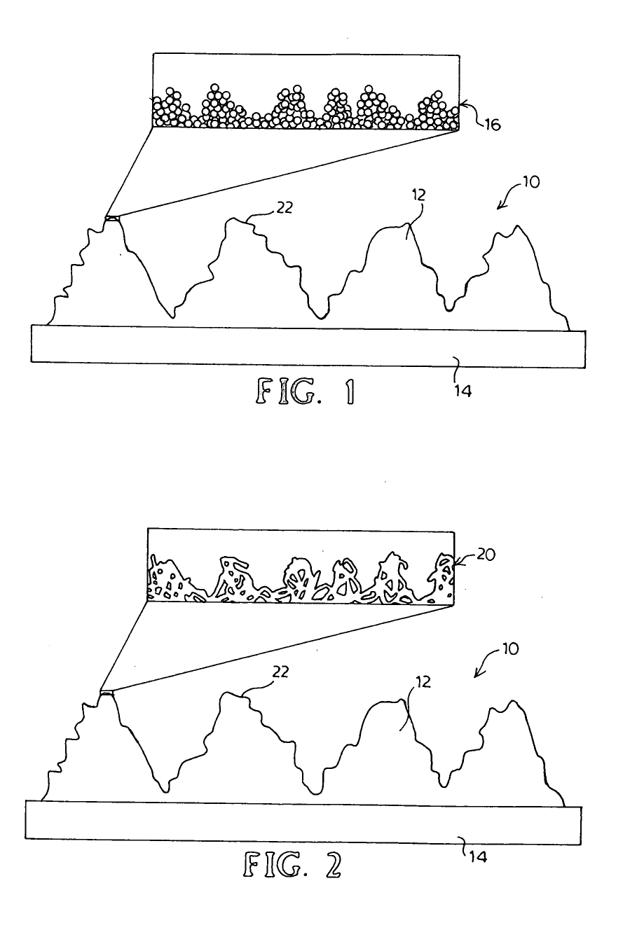

A most preferred way of shaping the structured surface is to deposit particles 12 in a thick multilayer, where each particle represents a first level of structure and where the randomly aggregated particles together in a first place form low peaks and shallow valleys representing a second level of structure and in a second place form high peaks and deep valleys forming a third level of structure (e.g. aggregated spheres forming a hierarchical structure, aggregated tubes forming a hierarchical structure, etc., see examples in FIGS. 1 and 2).

Another preferred way of achieving the surface structure in an electronically switchable material is by depositing electronically switchable material on top of pre-structured substrates.

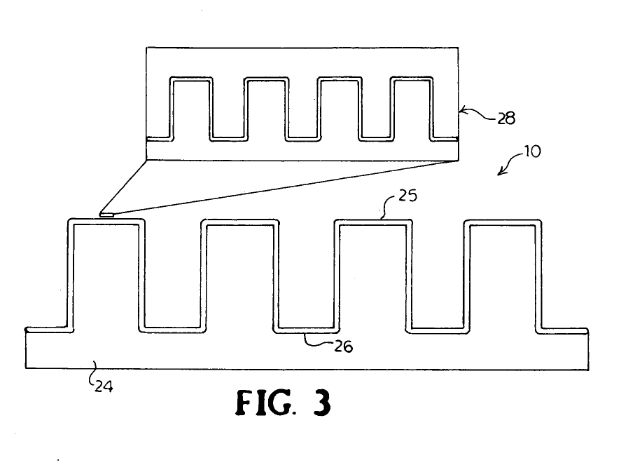

A first preferred way is to shape the structured substrate first (e.g. by injection molding, hot embossing, imprint lithography, etc.) and then deposit the possible electrode material, the possible electrolyte material and the electronically switchable material (e.g. by printing), see examples in FIG. 3.

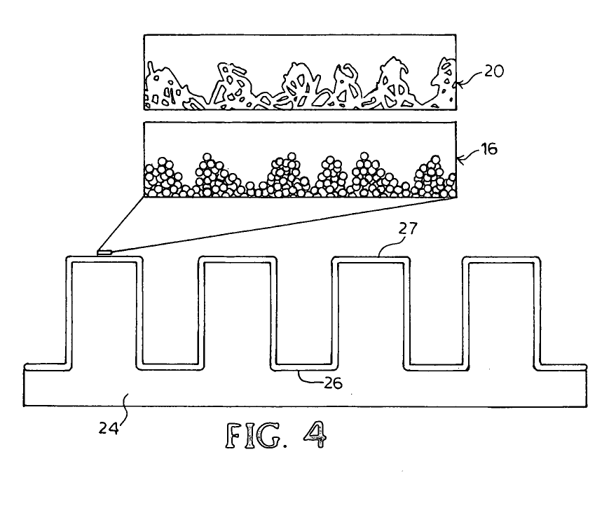

A second preferred way is to shape the structured substrate first (e.g. by injection molding, hot embossing, imprint lithography, etc.) and then deposit the possible electrode material, the possible electrolyte material and the particles according to above (e.g. by printing), where at least the outermost perimeter of the particles is made of an electronically switchable material, see examples in FIG. 4.

A third preferred way is to deposit the possible electrode material first (e.g. printing) and then shape the structured substrate (e.g. by embossing, hot embossing, etc.) and then deposit the possible electrolyte material and the electronically switchable material (e.g. by printing), see examples in FIG. 3.

A fourth preferred way is to deposit the possible electrode material first (e.g. by printing) and then shape the structured substrate (e.g. by embossing, hot embossing, etc.) and then deposit the possible electrolyte material and the particles according to above (e.g. by printing), where at least the outermost perimeter of the particles is made of an electronically switchable material, see examples in FIG. 4.

Another preferred way of achieving the surface structure in an electronically switchable material is by shaping the structure in a pre-deposited electronically switchable material.

A first preferred way is to deposit the possible electrode material, the possible electrolyte material and the electronically switchable material first (e.g. by printing) and then shape the structure in the pre-deposited material/materials (e.g. by embossing, hot embossing, etc.), see examples in FIG. 3.

A second preferred way is to deposit the possible electrode material, the possible electrolyte material and the particles according to above (e.g. by printing), where at least the outermost perimeter of the particles is made of an electronically switchable material, and then shape the structure in the pre-deposited material/materials (e.g. by embossing, hot embossing, etc.), see examples in FIG. 4.

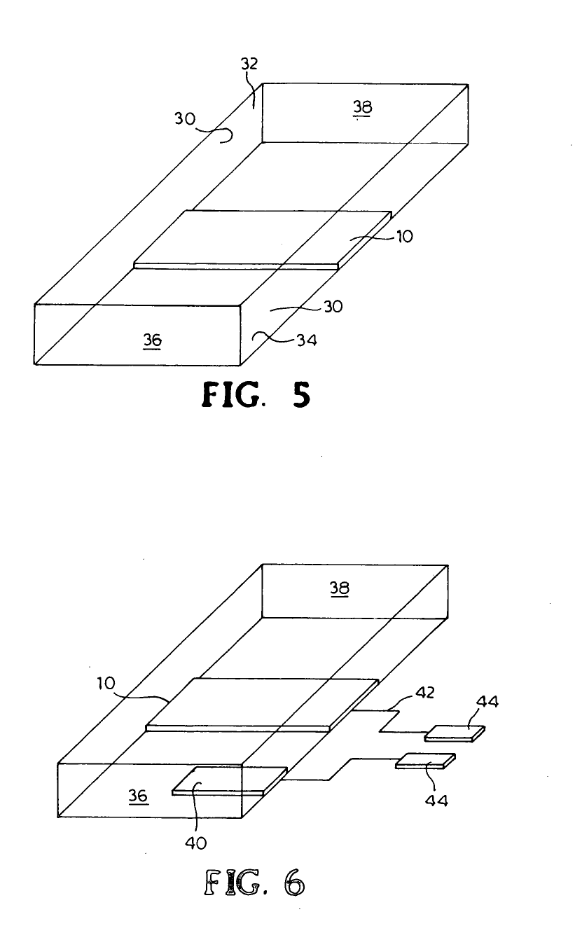

An example of a surface switch integrated in a micro-channel according to an embodiment of the present invention is shown in FIG. 5. The inner side of one or more channel walls can be hydrophilic in order to promote capillary flow from one end to another. The upper surface of the surface switch can be hydrophobic in its natural state. The upper surface of the surface switch may respond to electrical stimulus by getting hydrophilic. The micro-channel can be constituted so that the inner side surface of the channel walls, locally in the nearest proximity of the switch, has a high contact angle in order to help the surface switch to stop the flow in the channel. The micro-channel can be constituted so that it has a geometrical expansion or contraction, e.g. micro- and/or nano-trenches crossing the walls perpendicular to the flow direction) or a high contact angle material in the nearest proximity of the switch in order to help the switch stop the flow in the channel.

An example of a surface switch and a reference electrode integrated in a micro-channel with external connectors 42 and contact pads 44 according to an embodiment of the present invention is shown in FIG. 6. The integrated surface switch and reference electrode are electronically connected through connectors 42 with contact pads 44 for possible connection with an external power source so that the wettability of the switch can be easily manipulated from the external power source. The placement of the reference electrode includes but is not limited to anywhere upstream of the flow from the surface switch and under the surface switch or outside the channel in the case of a switch with an integrated dry electrolyte layer. The connectors are preferably placed so that they do not interfere with the flow including but not limited to outside the channels or inside the channels but with an insulating layer between the connector and the flow. The contact pads are preferably placed so that they are easily accessed by an external power source. The reference electrode, the connectors and the contact pads can be made of any conducting material including but not limited to carbon, conducting polymer or metal.

An embodiment of how to form a microfluidic system comprising a surface switch and a reference electrode integrated in a micro-channel, connectors and contact pads outside the micro-channel and a lid covering the micro-channel according to the present invention is described hereinafter. A preferred way is to fabricate an open micro-channel, form the surface switch and the reference electrode in the channel and form the connectors and the contact pads outside the channel (e.g. by first fabricating the open micro-channel and then printing inside and outside the channel or by first printing on a micro-channel substrate and then embossing the open micro-channel in the substrate through the printed surface switch and reference electrode so that the switch and the reference electrode ends up at the bottom and/or on the walls of the channel and so that the connectors and the contact pads ends up outside the channel). The channel can then be covered with a lid.

Another preferred way is to fabricate an open micro-channel and form the surface switch, reference electrode, connectors and contact pads on a lid (e.g. fabricating the open micro-channel and printing the lid with a possible structuring step before or after). The channel can then be covered with the lid, having the surface switch and the reference electrode facing the channel.

The micro-channel can be fabricated by any fabrication method including but not limited to micro-injection molding, hot embossing, nano-imprint lithography and lamination of plastic foils. The formed micro-channel can either have the right surface properties directly after forming or be surface modified after forming.

A preferred way of fabricating the micro-channel is by forming the channel with any method capable of forming microfluidic chips piece by piece (i.e. handling of one open chip at a time, e.g. micro-injection molding, etc.).

A more preferred way of fabricating the micro-channel is by forming the channel with any method capable of forming microfluidic chips sheet by sheet (i.e. handling of sheets with several open chips at a time, e.g. hot embossing, Nano Imprint Lithography (NIL), lamination, etc.).

A most preferred way of fabricating the micro-channel is by forming the channel with any method capable of forming microfluidic chips roll to roll (i.e. handling of rolls with open chips at a time, e.g. R2R (roll-to-roll) hot embossing, R2R NIL, R2R lamination, etc.).

The lid can be constituted of a sheet or foil of a material matching the requirements on the micro-channel materials described above, possibly also surface modified in the same way as the micro-channel materials described above, on top of which the surface switches, reference electrodes, connectors and contact pads are formed.

The side of the sheet or foil facing the micro-channel preferably has a durable hydrophilic surface that withstands the fabrication processes and a shelf life of two years without changing properties. A preferred lid base material is hydrophilic silicon oxide coated plastic foil e.g. SiOx-coated PET, SiOx-coated COP, etc. The SiOx-surface can in turn have been surface modified according to the above.

The surface switches, reference electrodes, connectors and contact pads can be formed on the lid or in the micro-channel with any fabrication methods including but not limited to any printing methods and embossing methods. The lids, the micro-channel substrates or the open microfluidic chips can be precut sitting on a carrier sheet or foil or be cut out of the sheet or foil after printing.

A preferred way of fabricating the lid or the micro-channel with an integrated switch is by forming the surface switches, reference electrodes, connectors and contact pads on a sheet or foil with any method capable of forming lids sheet by sheet (i.e. handling of sheets with several lids at a time, e.g. screen, inkjet, embossing, hot embossing, etc.).

A more preferred way of fabricating the lid or the micro-channel with an integrated switch is by forming the surface switches, reference electrodes, connectors and contact pads on a sheet or foil with any method capable of forming lids roll to roll (i.e. handling of rolls with numerous lids at a time, e.g. rotary screen, gravure, flexography, inkjet, R2R hot embossing, R2R NIL, etc.).

The fabrication of the lid can be performed in steps and can involve including but not limited to printing, embossing, sintering and annealing in a R2R process.

A preferred way is to print the surface switches, the reference electrodes, the connectors and the contact pads all together, followed by a possible and a common sintering and/or annealing and/or curing step.

A more preferred way is to print the metallic materials first followed by a possible embossing step and a possible sintering step (embossing either before or during sintering in the softer particle based material or after sintering in the harder sintered material) and then print the possible electrolytes and possible polymers followed by a possible embossing step and annealing step.

The printing steps can be followed by doping, in the case of conducting polymers, or surface modification, in the case with metals or carbon. Preferably the conducting polymers are doped (e.g. chemically polymerized, etc.) and the metals are surface modified before printing.

To form a complete microfluidic system according the present invention, the lid is bonded to the open microfluidic chip with the surface switch and the reference electrode facing the micro-channel. The methods for bonding the lid to the open microfluidic chip include but are not limited to glue based methods, solvent based methods, heat based methods, adhesive based methods, etc.

A preferred way of bonding the lid and the microfluidic chip is by any method capable of bonding the lid to the chip piece by piece (i.e. bonding one lid to one open chip at a time, e.g. stack lamination, etc.).

A more preferred way of bonding the lid and the microfluidic chip is by any method capable of bonding the lid to the chip sheet by sheet (i.e. bonding sheets of lids to sheets of open chips at a time, e.g. stack lamination, etc.).

A most preferred way of bonding the lid and the microfluidic chip is by any method capable of bonding the lid to the chip roll to roll (i.e. bonding rolls of lids with rolls of open chips at a time, e.g. R2R lamination, etc.).

In order not to interfere with the performance of the surface switch and the channel surface represented by the lid all above mentioned bonding processes are constituted so that they do not modify the surface switch or the channel surface represented by the lid (e.g. the adhesive layers can be cut and any glue or solvents can be deposited so that they are not covering the surface switch and the channel surface represented by the lid).

The above describes how to produce a microfluidic chip with integrated high performance surface switches according to the present invention, capable of electronically controlling the fluids in the chip. The surface switch initial contact angle depends on which electronically switchable material is used and what surface structure the switch is having. By applying a voltage over the surface switch towards a reference electrode the wettability of the surface switch can be controlled. The voltage needed for a complete switch, e.g. from highly hydrophobic to highly hydrophilic is typically 1-3 V.

A preferred application of the present invention is to use the surface switch to stop and start flows in micro-channels. The flows are preferably capillary driven but can also be pump-driven. When the flow encounters the surface switch, which crosses a wall of the micro-channel and is hydrophobic in its natural non-actuated state, it stops. By applying a voltage of typically 1-3 V over the surface switch towards the reference electrode, the surface switch turns hydrophilic and lets the fluid pass the surface switch.

Another preferred application of the present invention is to use the surface switch to control which channels to enter. When the fluid is in a container with channels leading out from the container, surface switches can be positioned where each channel meet the container in order to control which channels the fluid should enter.

Another preferred application of the present invention is to use the surface switch to make a pulsed flow. By positioning several surface switches close to each other or by splitting one surface switch into a finger-formed switch in the flow direction, the switches can be actuated in a sequence so that a “pulsed” flow is achieved.

Another preferred application of the present invention is to use the surface switch to control the flow velocity in a micro-channel. The surface switch can be formed as an elongated element along the micro-channel. The wettability and thereby the flow velocity can then be controlled by altering the voltage towards the reference electrode, typically 0-3 V.

Another preferred application of the present invention is to use the surface switch to cut off flows by positioning a surface switch in the middle of a four-way channel intersection, where two channels facing each other are hydrophilic and the other two are hydrophobic. A fluid propagating in one of the hydrophilic channels stops by the switch in the intersection. When the voltage of typically 1-3 V is applied the fluid passes the intersection and propagates further into the next hydrophilic channel. When the voltage is lowered to 0 V again the surface switch turns hydrophobic again. Due to the hydrophobic switch and the air in the hydrophobic channels, the cohesive forces of the fluid win over the adhesive forces between the fluid and the surface switch which makes the fluid in the intersection split in two parts and move back into the hydrophilic channels.

Another preferred application of the present invention is to use the surface switch for performing digital microfluidics, without needing the high voltages. This allows handling of droplets rather than flows.

Another preferred application of the present invention is to use the surface switch to achieve controlled sequential flows of different fluids in a micro-channel. In its simplest form it can consist of one fluid-exchanging channel ending up in a surface switch controlled waste and a surface switch controlled flow channel leading out in a perpendicular direction from the fluid-exchanging channel. When a first fluid enters the system it fills the system until the first switches in the controlled flow channel and the waste system. By actuating the first switch in the waste system the second fluid is sucked into the fluid exchanging channel. By then actuating the first switch in the controlled flow channel the second fluid is sequentially sucked into the controlled flow channel until the first fluid encounters the second switch in the controlled channel. This sequence can be repeated as many times as wanted, thus handling many different fluids. The solution can be scaled to handle many parallel controlled flow channels.

### Example 1

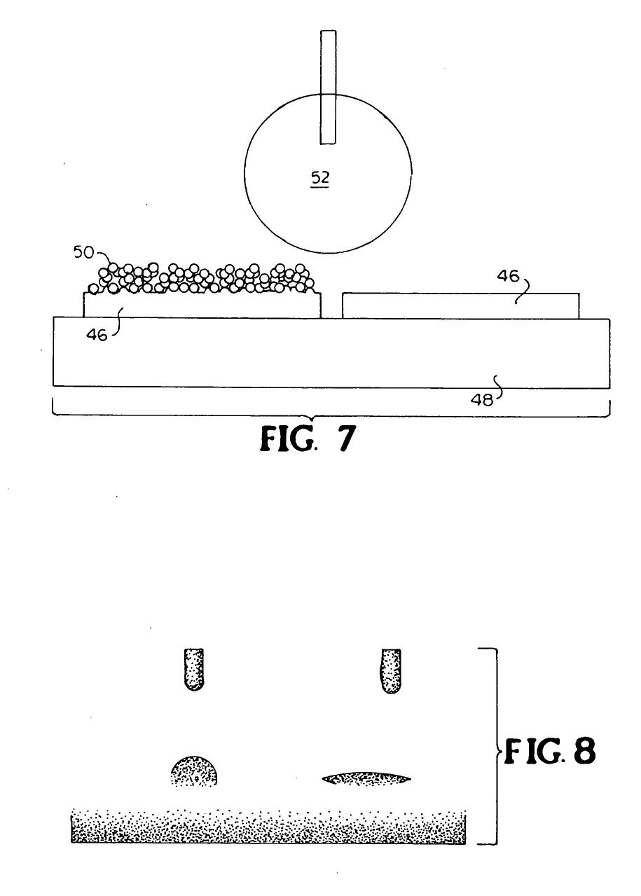

A surface structured wettability switch 10 was developed (see FIG. 7). The performance of the switch was to switch from a stabile hydrophobic state with a contact angle above 90 degrees to a hydrophilic state with a contact angle below 30 degrees in about 1 second. The gold electrodes 46 were evaporated on to a glass slide 48 with a non coated 1 mm wide glass area separating the two electrodes 46. On top of one of the electrodes 46 Au-coated SiO₂ particles 50 (referred to as nanoparticles from now on) were inkjet printed. All experiments were performed in Class 10000 laboratory environment, RH˜40%, 20° C. with an exception made for Atomic Force Microscopy (AFM), which were performed in Class 1000 laboratory environment, RH˜40%, 20° C.

The gold electrodes 46 were evaporated with 30-50 Å Ti as adhesion enhancer and a ˜1 mm thick metallic thread as a mask between the two electrodes 46. Standard glass microscopy slides 48 were used as substrates. Citrate stabilized Au@SiO-particles 50 (˜20 nm Au on ˜100 nm SiO₂ particles) were purchased from PlasmaChem GmbH, Germany, and mixed in 1-octanol (10 mg particles in 1 ml 1-octanol). Printing was made with a Dimatix Materials Printer (DMP-2831, Fujifilm Dimatix Inc, USA) with printing heads generating 10 picoliter drops. Contact angles were measured in static mode by use of an optical contact angle meter (CAM 200, KSV Instruments, USA) with 1 M KCl.

A glass slide 48 with two evaporated gold electrodes 46 was prepared as described above. The Au@SiO-particles 50 in 1-octanol mixture, prepared as described above, were then inkjet printed on one of the evaporated Au electrodes 46 and cured at 210° C. for 10 minutes. The sample was rinsed with deionized (DI) water and blown dry with air.

The glass slide 48 with the two gold electrodes 46, of which one was prepared with Au@SiO-particles 50, was then placed in the contact angle meter and connected through an electrically conducting tape to an external power source. A drop 52 of 1 M KCl was applied between the two electrodes 46, so that it electrically connected the two electrodes 46.

The contact angle representing the hydrophobic state was first measured before any voltage was applied (0 V). 2 V was then applied over the electrodes 46 and the contact angle representing the hydrophilic state was then measured again (2 V). The initial hydrophobic contact angle was under the influence of 0 V determined to 97 degrees. Under the influence of 2 V the contact angle decreased within about 1 second to 16 degrees (see FIG. 8).

### Example 2

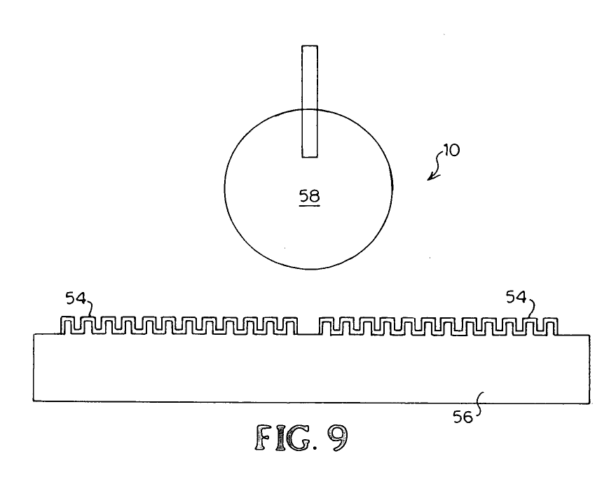

A surface structured wettability switch 10 is developed (see FIG. 9). The performance of the switch 10 is to switch from a stabile hydrophobic state with a contact angle above 100 degrees to a hydrophilic state with a contact angle below 30 degrees in about 1 second. The plastic foil 56 is embossed and the gold electrodes 54 are inkjet printed on top of the embossed substrate with a 500 um wide area separating the two electrodes. All experiments are performed in Class 10000 laboratory environment, RH˜40%, 20° C.

The plastic PC foil 56 (Makrofol DE 1-1) is purchased from Bayer Material Science, Germany. The gold nanoparticle ink (NPG-J) is purchased from Harima, Japan. The PC foil 56 is placed in a hot embossing machine (DecoPrint P-2000, Magdag Printing Systems, Switzerland) and is embossed with a microstructured stamp (MLA-B, NIL Technology APS, Denmark). The gold nanoparticle ink is printed on the microstructured PC foil with an inkjet printer (DMP-2831, Fujifilm Dimatix Inc, USA) with printing heads generating 10 picoliter drops. The sample is then flash sintered using a flash sintering machine (PulseForge 3100, Novacentrix, USA) with a pulse length of 1 ms.

The microstructured and printed sample is then placed in a contact angle meter (CAM 200, KSV Instruments, USA) and connected to an external power source. A drop 58 of Phosphate Buffered Saline, 1× solution PBS prepared from a 10× concentrate purchased from Sigma-Aldrich in USA, is applied between the two electrodes 54 so that it is electrically connected to the two electrodes 60.

The contact angle representing the hydrophobic state is first measured before any voltage is applied (0 V). 3 V was then applied over the electrodes 54 and the contact angle representing the hydrophilic state is then measured (3 V). The initial hydrophobic contact angle is under the influence of 0 V measured to 105 degrees. Under the influence of 3 V the contact angle decrease within one second to 27 degrees.

### Example 3

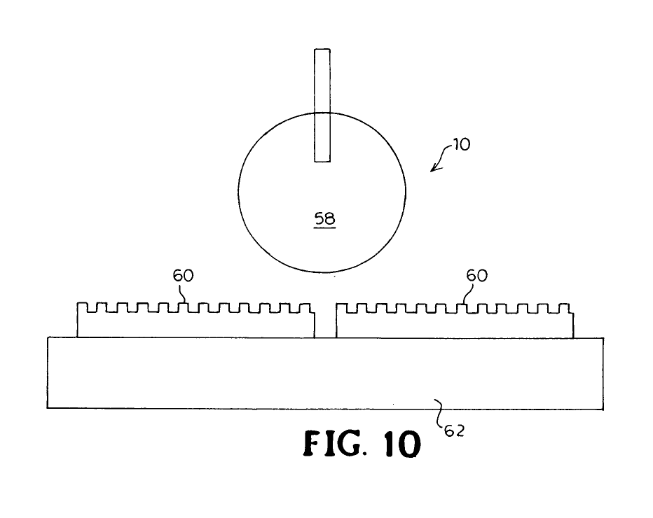

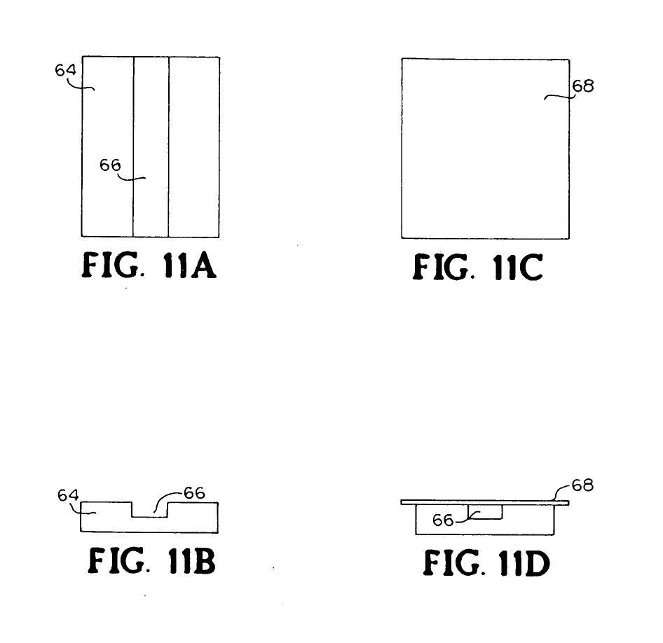

A surface structured wettability switch 10 is developed (see FIG. 10). The performance of the switch 10 is to switch from a stabile hydrophobic state with a contact angle above 100 degrees to a hydrophilic state with a contact angle below 30 degrees in about 1 second. The gold electrodes 60 are inkjet printed and embossed on plastic foil 62 with a 500 μm wide area separating the two electrodes 60. All experiments are performed in Class 10000 laboratory environment, RH˜40%, 20° C.

The plastic PEN foil 62 (Teonex Q65FA) is purchased from Teijin DuPont Films, Japan. The gold nanoparticle ink (NPG-J) is purchased from Harima, Japan. The gold nanoparticle ink is printed on the foil with an inkjet printer (DMP-2831, Fujifilm Dimatix Inc, USA) with printing heads generating 10 picoliter drops.

A PEN 62 film is prepared with two gold electrodes 60 as described above. The PEN film 62 with the two electrodes 60 is then placed in a hot embossing machine (DecoPrint P-2000, Magdag Printing Systems, Switzerland) and the gold electrodes 60 are embossed with a nanostructured stamp (Negative of LAP 300 (area 4), NIL Technology APS, Denmark). The sample is then flash sintered using a flash sintering machine (PulseForge 3100, Novacentrix, USA) with a pulse length of 1 ms.

The printed and nanostructured sample is then placed in a contact angle meter (CAM 200, KSV Instruments, USA) and connected to an external power source. A drop 58 of Phosphate Buffered Saline, 1× solution PBS prepared from a 10× concentrate purchased from Sigma-Aldrich in USA, is applied between the two electrodes 60 so that it is electrically connected to the two electrodes 60.

The contact angle representing the hydrophobic state is first measured before any voltage is applied (0 V). 3 V was then applied over the electrodes 60 and the contact angle representing the hydrophilic state is then measured (3 V). The initial hydrophobic contact angle is under the influence of 0 V measured to 110 degrees. Under the influence of 3 V the contact angle decrease within one second to 25 degrees.

### Example 4

A microfluidic system is fabricated according to the invention by making an open microfluidic chip 64 with lamination methods, fabricating a lid 68 with a switch 10 and a reference electrode according to Example 1 and then sealing the open chip with the lid.

The microfluidic chip 64 has the outer dimensions of a glass slide and is constituted as in FIG. 6 of a straight channel (microchannel 66) with one inlet and one outlet. The channel is formed by laser cutting through a plastic carrier foil with an adhesive layer on each side (100 μm thick PET including adhesive, Tesa SE, Germany) and then laminating the cut foil to a non-cut foil, resulting in an open microfluidic chip 64 with an adhesive layer on the open side. The cut foil represents the channel side walls 30 (FIG. 5). The non-cut foil represents the channel top wall 32 and can have a hydrophilic SiO₂-coating (P008, Ceramis, Switzerland) on the side facing the channel. The switch and the reference electrode are fabricated according to Example 1, resulting in a switch and a reference electrode on a glass slide. The open microfluidic chip with the open adhesive layer is then laminated to the glass slide so that the switch and the reference electrode are facing the channel according to FIG. 6.

When a drop of fluid is applied to the channel end marked “flow in” 36 in FIG. 6 it enters the channel due to the hydrophilic glass-bottom and the hydrophilic SiO₂-top of the channel. The fluid propagates through the channel until it reaches the surface switch, where it stops due to the surface switch natural non-actuated hydrophobic state.

Through applying a voltage of 2 V over the surface switch towards the reference electrode, as described in Example 1, the surface switch turns hydrophilic and lets the fluid pass. The fluid will then, due to capillary forces, propagate further through the channel until reaching the channel end marked “Flow out” 38 in FIG. 6 where it stops.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A microfluidic system comprising:
a) at least one micro-channel having a wall with an inner side;
b) a printed structured surface having an outermost perimeter having a wettability, wherein at least the outermost perimeter of the printed structured surface comprises an electronically switchable material, attached to or forming part of the inner side of the wall to provide a surface switch; and
c) means for applying electronic stimuli to the surface switch to cause a change in wettability.

2. The microfluidic system according to claim 1, wherein the structured surface is discrete particle based or made by hot embossing or micro injection molding or reaction injection molding or laser ablation or etching or made by nano imprint lithography or by any combination thereof.

3. The microfluidic system according to claim 1, wherein the structured surface is formed on a flat or pre-structured substrate.

4. The microfluidic system according to claim 1, wherein the channel is formed from a polymeric material or glass.

5. The microfluidic system according to claim 1, wherein the electronically switchable material is a material of which the wettability can be manipulated by altering the voltage.

6. The microfluidic system according to claim 1, wherein the electronically switchable material is made of metal, conducting polymer or carbon.

7. The microfluidic system according to claim 1, wherein the structured surface comprises printed particles.

8. The microfluidic system according to claim 1, wherein the surface structure of the outermost perimeter of the switch is shaped by printing electronically switchable material on top of pre-structured substrates.

9. The microfluidic system according to claim 1, wherein the surface structure of the outermost perimeter of the switch is shaped in a pre-deposited electronically switchable material.

10. The microfluidic system according to claim 1, wherein the electronically switchable material is deposited in the form of particles, wherein at least the outermost perimeter of the switch is formed from the electronically switchable material.

11. A microfluidic system comprising:
a) at least one micro-channel having a wall with an inner side;
b) a discrete particle based-surface having an outermost perimeter having a wettability, wherein at least the outermost perimeter is made of an electronically switchable material, attached to the inner side of the wall to provide a surface switch; and
c) means for applying electronic stimuli to the surface switch so as to cause a change in wettability.

12. The microfluidic system according to claim 11, wherein the inner side surface of the channel walls, located in the nearest proximity to the switch, is hydrophobic in order to help the surface switch stop flow in the channel.

13. A method for the manufacture of a microfluidic system comprising at least one micro-channel having a wall with an inner side, the method comprising the steps of:
a) fabricating a microfluidic chip;
b) forming a surface switch on the inner wall; and
c) providing means for applying electronic stimuli.

14. The method according to claim 13, wherein fabricating the microfluidic chip, forming the surface switch, and providing the means for applying stimuli comprise:
a) printing the surface switch, a reference electrode, connectors and a contact pads on a micro-channel substrate;
b) embossing an open micro-channel in the micro-channel substrate through the printed surface switch and reference electrode so that the surface switch and the reference electrode are at the bottom and/or on the walls of the micro-channel and so that the connectors and the contact pads are outside the channel; and
c) bonding a lid on top of the channel to cover the channel and form the microfluidic system.

15. The method according to claim 13, wherein the forming of the surface switch is performed in one or more steps separated or followed by one or more of a drying, sintering, annealing, curing and a surface structuring step, preferably hot embossing, for achieving the surface structure of the surface switch.

16. The method according to claim 13, wherein fabricating the microfluidic chip, forming the surface switch, and providing the means for applying stimuli comprise:
a) fabricating an open micro-channel;
b) printing the surface switch and a reference electrode inside the micro-channel and connectors and contact pads outside the micro-channel; and
c) bonding a lid on top of the channel to cover the channel and form the microfluidic system.

17. The method according to claim 13, wherein fabricating the microfluidic chip, forming the surface switch, and providing the means for applying stimuli comprise:
a) fabricating an open micro-channel;
b) printing the surface switch, a reference electrode, connectors and contact pads on a lid and
c) bonding the lid on top of the micro-channel, having the surface switch and the reference electrode facing the micro-channel, to cover the channel and form the microfluidic system.

18. A method for controlling a fluid flow through a micro-channel of a microfluidic system according to claim 1, the method comprising:
a) propagating the fluid in the micro-channel by pump actuation or capillary forces;
b) stopping the fluid by a surface switch, due to a hydrophobic natural state of the fluid; and
c) applying a voltage over the surface switch towards a reference electrode, causing the surface switch to go to an actuated hydrophilic state, letting the fluid flow pass and propagate further.
